(19) United States
(12) Patent Application Publication
(10) Pub. No.: US 2012/0273418 A1
(43) Pub. Date: Nov. 1, 2012

(54) BORON RECOVERY TREATMENT METHOD

(76) Inventors: Dennis A. Brunsell, Knoxville, TN (US); Charles E. Jensen, Knoxville, TN (US); Larry E. Beets, Knoxville, TN (US)

(21) Appl. No.: 13/468,034

(22) Filed: May 10, 2012

Related U.S. Application Data
(63) Continuation-in-part of application No. PCT/US12/23051, filed on Jan. 28, 2012.
(60) Provisional application No. 61/438,249, filed on Jan. 31, 2011.

(51) Int. Cl. C02F 9/10; C02F 9/04; C02F 101/10

(52) U.S. Cl. 210/639; 210/202; 210/182; 210/190; 210/180

(57) ABSTRACT

A system (10) for processing and treating a wastestream, NPP primary water or like fluid from a PWR, VVER or other boron moderated reactor source is disclosed. The system allows discharge amounts of boron to be safely lowered and selectively recovered as a solid for disposal and recycled or reused in other fluid forms; and allows for replenishing of high pH subsystems needed in situ by internal coordinated use of regeneration fluids.

### CROSS-REFERENCE TO RELATED APPLICATION

This application is a continuation-in-part of International application No. PCT/US12/23051, filed Jan. 28, 2012 (Jan. 28, 2012), which claims the benefit of U.S. Provisional Application No. 61/438,249, filed Jan. 31, 2011 (Jan. 31, 2011); each of which is incorporated by reference in their entirety herein.

### BACKGROUND OF THE INVENTION

1. Field of the Invention

The present invention relates to a Method, Process or System for processing and treating a wastestream, NPP primary water or like fluid from a PWR or other boron moderated reactor (or BMR) such that discharge amounts of boron can be lowered and recovered; and greater safety measures in this regard can be brought about for the environment.

2. Background Information

In this technology Boron has been used as a neutron moderator Pressurized Water Reactors (PWR's), Russian VVER Reactors and other boron moderated reactors (BMR's). The actual moderator is the B10 isotope, which represents about 19.8% with the remainder being B11 at about 80.2% in natural occurring boron. The B10 consumes neutrons from the nuclear fission reaction, and are absorbed.

A normal PWR plant discharges 0.5 to 1 million gallons of water annually that averages about 400 ppm of boron. Plants that discharge into an ocean or other body of water that is not to be used for agricultural or potable water have unlimited discharge permits with regards to boron concentration in the environmental effluent. Most other PWR plants have limits on the boron discharge because of adverse effects on health and agricultural development. This negative agricultural effect is shown by natural concentration of Boron into agricultural products, with extended concentration, upon cattle consumption, into meat processed and sold for human consumption, or direct consumption of grains, vegetables and fruits. Most developed countries limit boron discharges to about 1 ppm. The drinking water limit is 0.5 ppm.

The concentration of boron required to moderate a PWR varies over the life of the fuel from about 2500 ppm to near zero at the end of the fuel cycle. The Russian VVER plants run in a range of about 2800 to 3600 ppm. Past practices usually involved the dilution of reactor water with deionized water and discharge of the excess water to the environment after removal of gamma producing radioisotopes. This resulted in the discharge of 10-20 thousand pounds of boric acid annually for each reactor.

Some plants have converted and others are considering the use of highly enriched B10 boron so that boron concentrations could be reduced from 2500 ppm to about 500-600 ppm. In so doing, the B10 concentration remained about the same. In this process the cost of the enriched boron was much higher, but boron could then be recycled and reused for a longer period of time.

Boric acid evaporators have been used at several plants in the U.S. and at many plants in Europe and other continents. U.S. plants have encountered very high costs in maintaining the evaporators, and most have shutdown these evaporators and [have] sought less expensive alternatives. It would, therefore, be an advantage to the technology to be able to provide a less expensive alternative.

The evaporation of boric acid causes problems both in the powdery nature of the product and the nucleate nature of the boiling during evaporation. Such boiling during evaporation causes severe fouling in the fill head and downstream evaporate piping. It has been found at times that the fouling is so severe that the level probes become severely coated such that they are no longer functional. It was also found that the evaporate line also became plugged causing the vacuum to fail. This failure required shutting down the evaporation process until the evaporate line was flushed.

The use of normal anion resin removes boron well initially but boron can easily be displaced by chlorides, sulfates and other anions that have high affinity for the resin. These can completely displace the boron if not monitored.

Boric acid when evaporated to dryness forms a powdery and highly dispersible product. When radioactively contaminated, this can lead to either highly sophisticated airborne controls or internal contamination of workers.

It would, therefore, be an advantage in the technology to provide a method to recover boron for either disposal as a non-dispersible solid or recycle for reuse within PWR systems.

### SUMMARY OF THE INVENTION

The foregoing and other objects of the invention can be achieved with the present invention which provides for a novel process and accompanying equipment that permits the effective separation of boron from primary water from nuclear power plants utilizing boron as a neutron absorber in water.

In one aspect, the invention provides a system for processing and treating a wastestream, fuel or like fluid from a PWR so that discharge amounts of boron can be safely lowered and selectively recovered as a solid for disposal and recycled or reused in other fluid forms. The present inventive system includes the steps of:

(a) communicating the wastestream from a PWR source through a high basic pH adjustment station, and from the station to a first pass RO where the wastestream is divided by virtue of filtration into a first pass permeate and a first pass reject. The first pass reject contains substantial amounts of boron;

(b) directing the first pass permeate to a second high basic pH adjustment station if needed to retain high pH, and further directing the permeate to a second pass RO, where the permeate is divided by virtue of filtration into a second pass permeate and a second pass reject, each leaving the second pass RO. The second pass reject contains residual remaining amounts of boron; and

(c) passing at least a portion of the second pass permeate to at least a first polishing demin unit having boron specific selective resin, and from the at least first polishing demin unit to discharge or recycle.

The invention includes aspects thereof which constitute a combination of chemical, membrane, ion exchange, and precipitation and evaporation elements. These aspects provide for recycle or discharge of water at <(less than) 1 ppm Boron while concentrating the boron to a form that is easily disposed.

The system is based around a reverse osmosis system where the feed water is pH adjusted to greater than about 9 (>9) and preferably greater than about 10.5 (>10.5). This permits the highest rejection of borate. The second reason for pH adjustment is to maximize the solubility of the boron to prevent possible precipitation of the boron in the membranes, piping or DDHUT (36) of the present invention.

It is an object of the present invention to provide to PWR technology a less expensive alternative to boric acid evaporators.

It is a further object of the invention to provide a method to recover Boron which affords the selective advantages of safe disposal as a solid and recycle and reuse within the PWR, VVER (Russian Nuclear Plant) or other boron moderated reactor (BMR) systems.

It is yet a further object of the present invention to provide a system based around a reverse osmosis system where the feed water is pH adjusted to greater than about 9 (>9) and preferably greater than about 10.5 (>10.5); thereby permitting the highest rejection of borate and maximizing the solubility of the boron to prevent possible precipitation of the boron in the present invention's membranes, piping or DDHUT (36, later described herein).

### BRIEF DESCRIPTION OF THE DRAWINGS

FIG. 1 is a schematic illustration of the Boron Recovery Treatment Method and system of the present invention.

FIG. 1A is a partial or fragmentary schematic illustration of a portion of FIG. 1 showing emphasis for the route and communicated directionality of the pH-treated marshaled contents (33A).

FIG. 1B is a schematic illustration of a basic preferred embodiment of the present invention, where the DDHUT/DD subsystem is omitted from the system's operation and a reject collection tank (80) is used in lieu thereof.

FIG. 1C is a partial schematic illustration of a portion of FIG. 1 showing a preferred embodiment for transfer of the invention's regeneration solution (33A) to its IX unit (28) and from the IX unit to the invention's spent regeneration solution tank (34).

FIG. 1D is a partial schematic illustration of a portion of FIG. 1 showing a preferred embodiment for transfer of the invention's regeneration solution (33A) to its backup polishing demin (IX) unit (30) and from the IX unit (30) to the invention's spent regeneration solution tank (34).

FIG. 2 is a schematic illustration of an embodiment of the present invention. FIG. 3 is a schematic illustration of a further embodiment of the present invention.

FIG. 4 is a schematic illustration of yet a further embodiment of the present invention.

FIG. 5 is a schematic illustration of an embodiment of the invention where injection of a barium salt or barium hydroxide is utilized.

FIG. 6 is a schematic-sketch illustration of an example of the drum dryer means (38) utilized in the present invention.

FIG. 6A is a schematic-sketch illustration of another example of the drum dryer means (38).

FIG. 7 is a schematic illustration of an embodiment where the electro-deionization (EDI) unit (73) is used as, or in place of, the ion exchange media containing boron selective resin (29), for final boron polishing.

FIG. 8 shows an illustration of a Paddle or Fanning dryer (vacuum or ambient) used in a further preferred embodiment in regard to evaporation and concentration in the system and method of the present invention.

### REFERENCE NUMERALS AND ABBREVIATIONS

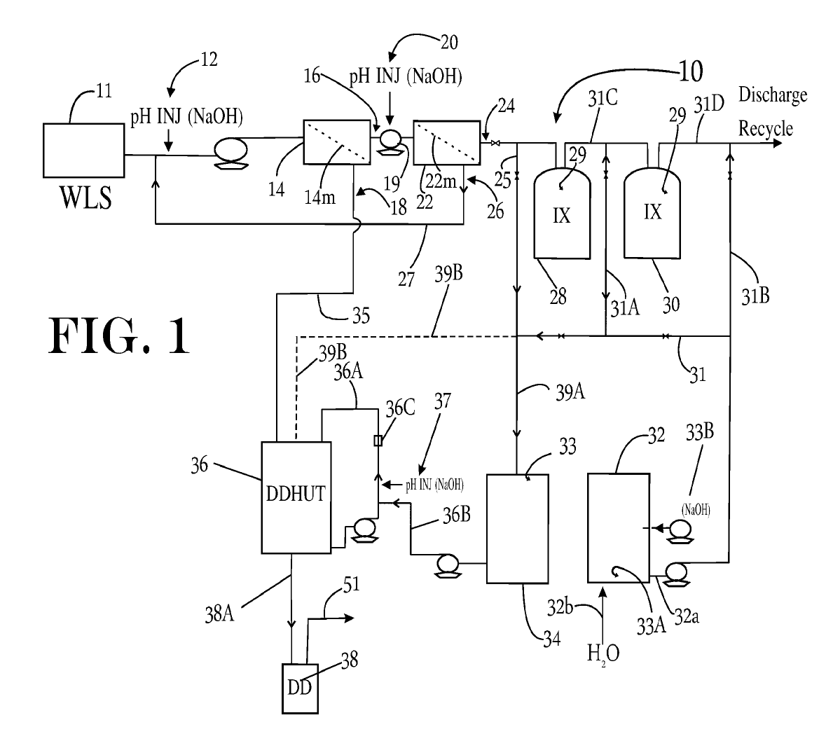

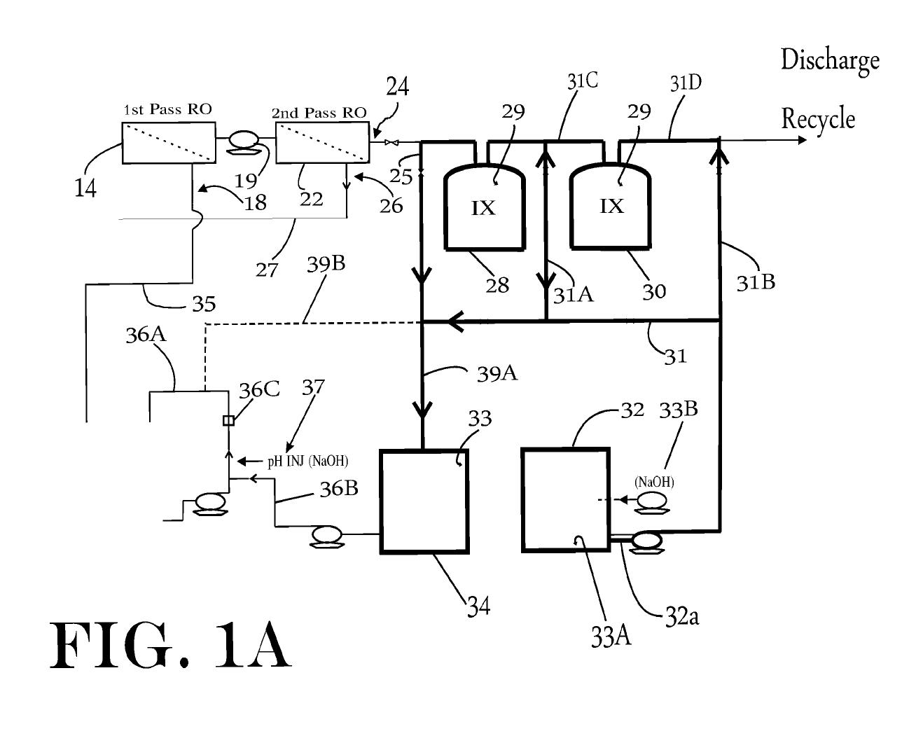

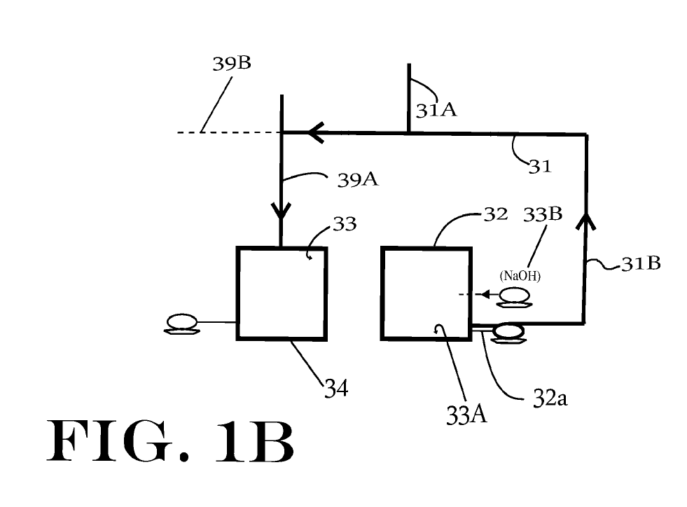

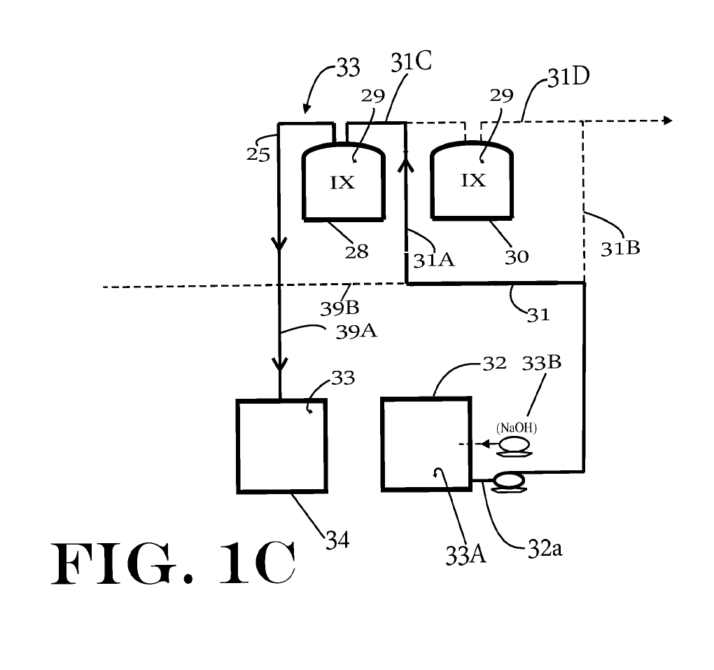

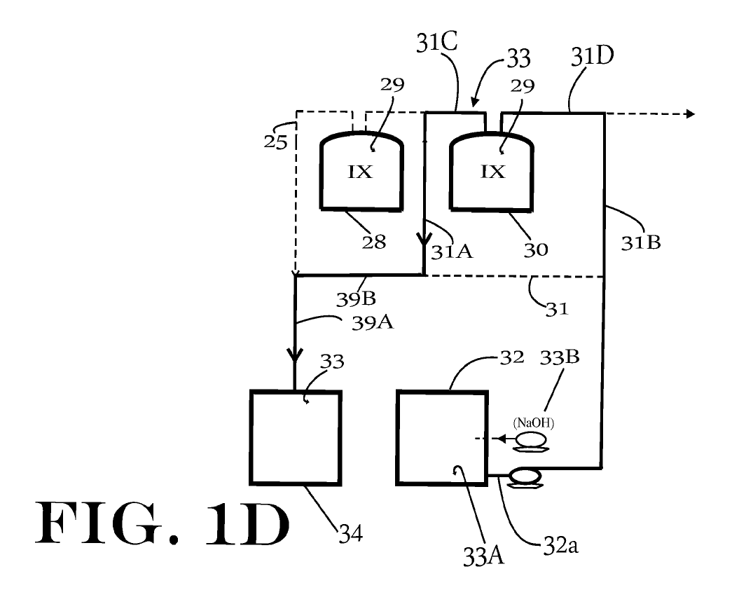

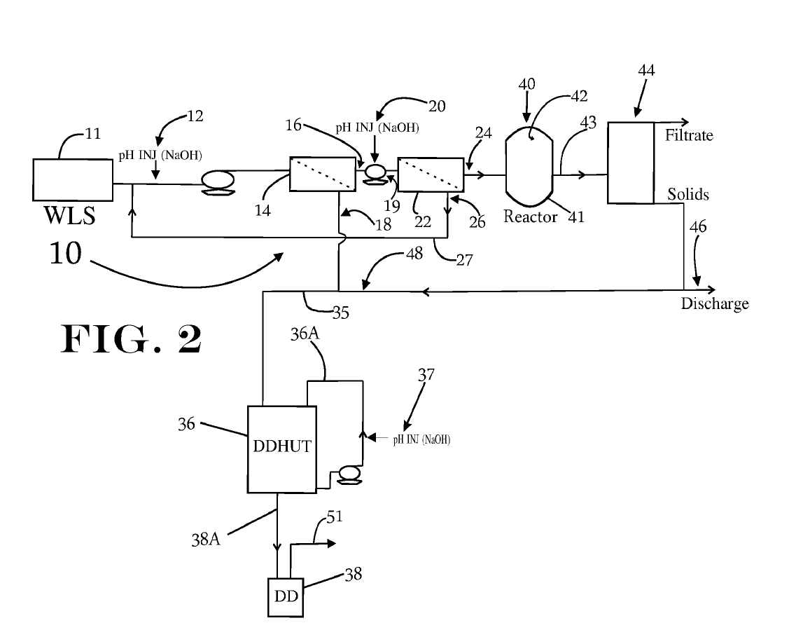

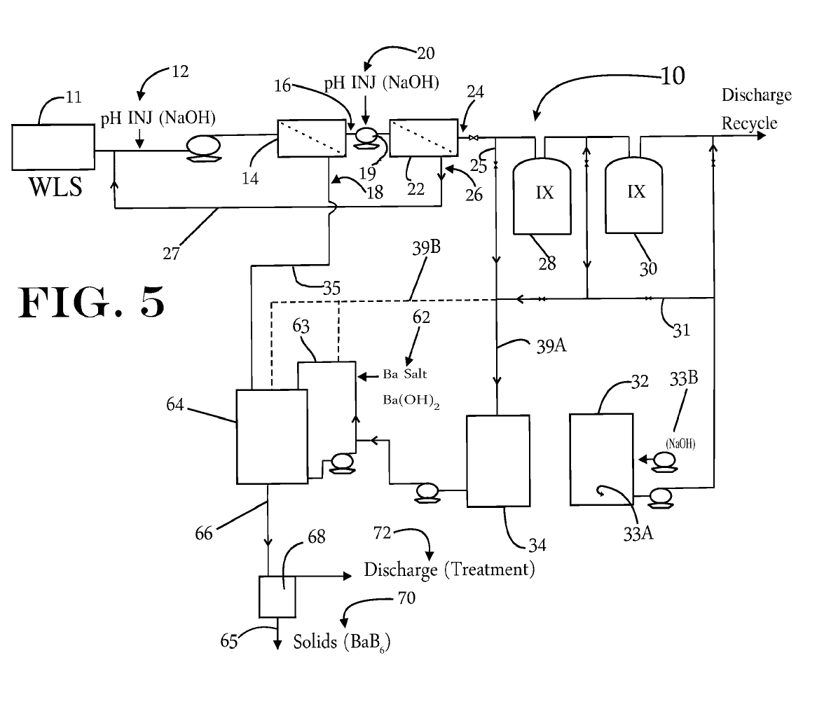

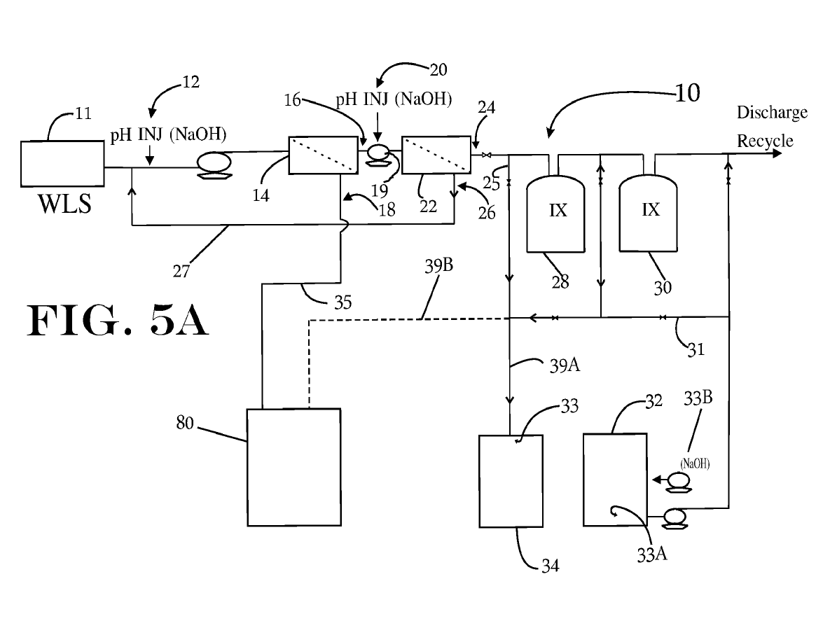

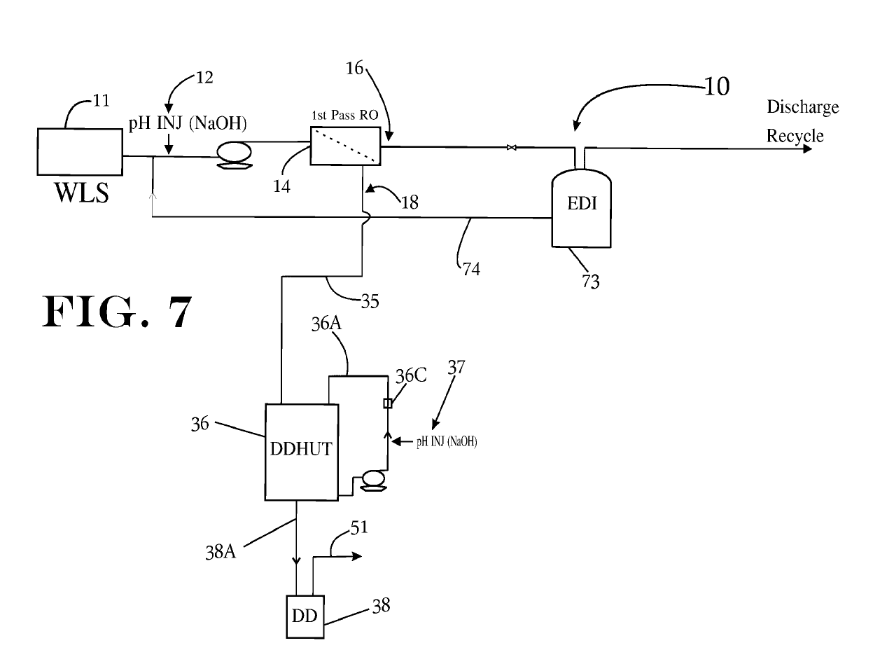

BRTM Boron Recovery Treatment Method
PWR Pressurized Water Reactor
VVER VVER Russian boron moderated reactor plants
BMR boron moderated reactor
RO reverse osmosis or reverse osmosis unit
10 method and system of boron recovery treatment, Boron Recovery Treatment Method (BRTM), method and system of the present invention, method or present invention
11 wastestream source location
12 high basic pH adjustment station
14 first (1st) pass RO (Reverse Osmosis) unit
14m membrane of RO unit (14)
16 first pass permeate fluid
18 first pass reject fluid or solution
19 transfer of first pass permeate (16) (the permeate so transferred)
20 second high basic pH adjustment station
22 second pass RO unit
22m membrane of RO unit (22)
24 second pass permeate
25 line used for transfer of the spent regeneration solution (33) from the IX unit (28) to the spent regen area (34) (FIG. 1C)
26 second pass reject
27 return or other communicative line to line leading to first pass RO unit 14
28 polishing demin unit or (IX) or IX unit, housing ion exchange media (29)
29 ion exchange media containing boron selective resin
30 polishing demin unit, or (IX) or IX unit, or backup polishing demin unit or (IX), housing ion exchange media (29)
31 line or communicating channel for passage or transfer of regeneration solution (33A) from the regen solution tank (32) to the line (31A) and the IX unit (28) (See FIG. 1C) and the communication channel for transferring spent regen solution from IX (30) coming through line 31A and being transferred to line 39A to spent regen solution area (34) or line 39B to the DDHUT (36).
31A line, channel or other communication serving, and allowing communication, between line (31C) and line (31) used to carry regeneration solution for IX (28) and spent regen solution for IX (30)
31B line or communication in part to the IX vessel (30) from the Regen Solution Tank (32) and line (32a) (FIG. 1D) and to line (31D); and in part used for transfer between the Regen Solution Tank (32) and line (32a) to line (31) leading to line (31A) leading to line (31C) and IX unit (28) (FIG. 1C)
31C line, channeling or other communication serving, and allowing communication, between the demin units (28) and (30), and connection with line (31A)
31D line or communication in part to Discharge or Recycle; and to communicate regeneration solution to IX (30) from line (31B).
32 regeneration solution tank or regen tank
32a line for communicating, transferring or channeling the regeneration solution (33) from the regen solution tank (32) to line (31B)
32b Water initially added to the regeneration solution tank (32) spent regeneration solution or spent regen solution
33A regeneration solution or regen solution contents in or originally coming from the regen tank (32)
33B high basic pH adjustment area or station
34 spent regeneration solution area or spent regen area
35 transferring or channeling (first pass reject 18)
36 feed holdup tank or drum dryer holdup tank (or DDHUT)
36A recycle line channeling or otherwise communicating the DDHUT (36) reject (18) to or with the high basic pH adjustment station (37) and Spent Regen transfer line (36B)
36B spent regen transfer line channeling or otherwise communicating the Spent Regen Solution (33) to the DDHUT recycle line (36A)
36C pH monitoring station
37 high basic pH adjustment station or pH adjustment station or pH adj
38 drum dryer means or DD having a drum portion (38B) for drying and evaporation to produce or generate a solid boron substance or substantially solid boron material inside the drum portion, which can be disposed of in situ or while contained in the drum
38A feed or other lined communication to the drum dryer means (38) of contents from the DDHUT (36)
38B drum or drum portion of the drum dryer (38)
39A line (shown by example) to the spent regen area (34)
39B line (shown by example) to the line (36A) or other communication means serving or otherwise connecting to the DDHUT (36)
40 chemical addition of a soluble Group IIA metal salt or hydroxide
41 reactor vessel or similar container for this purpose
42 precipitation of boron or boron precipitate
43 line or other means of communication from Reactor (41) to Solid Liquid Separation device (44)
44 solid liquid separation
46 solids collected separately
48 solids transferred or communicated to the DDHUT (36)
51 evaporated water or evaporate generated in the drum dryer (38) as a part of the process in the drum dryer (38)
52 water or air cooled condenser
62 injection or addition by other means of either barium hydroxide (Ba(OH)₂) or a soluble barium salt
63 line for injection of Ba(OH)₂ or soluble barium salt (FIG. 5)
64 reaction vessel for boron precipitation (FIG. 5)
65 Boron precipitate (FIG. 5)
66 reactor effluent line (FIG. 5)
68 solid liquid or solid/liquid separation means (FIG. 5)
70 solids in the form of BaB₆ (FIG. 5)
72 discharge or further treatment (FIG. 5)
73 Electro-deionization (EDI) unit (FIG. 7)
74 EDI concentrate line to line (36A) and DDHUT (36) (FIG. 7)
80 reject collection tank or means (FIG. 5A)
90 paddle or fanning dryer
91 container member of (90)
92 feed (→) from lines 35, 39B, 36A and/or the conveyance line or lines associated with these lines as shown in FIGS. 1, 1A, 2, 3, 4, and/or FIG. 7
94 separation column
95 steam discharged from (94)
96 steam or oil jacket heating area or compartment
98 pivotable paddle or fanning member or members
97 turning, pivoting or other movement of paddle members (98)
99 drive motor or other means for providing motion or movement to paddle member(s)
100 molten effluent discharge created in and ejected from container member (91)
101 ball valve used in relation to (100)
102 temperature probe placed to take measurements inside the container (91)

### DETAILED DESCRIPTION OF THE INVENTION

The following description of the preferred embodiments of the concepts and teachings of the present invention is made in reference to the accompanying drawing figures which constitute illustrated examples of the teachings, and structural and functional elements, of the invention; among many other examples existing within the scope and spirit of the present invention.

Referring now to the drawings, FIGS. 1 through 8, thereof, there is illustrated, by schematic means, schematic sketch and drawing illustration, exemplary embodiments of the present invention addressing the method and system of Boron Recovery Treatment shown at 10; and referred to hereafter as the BRTM, the method and system, the Method or the invention 10. It will be understood that a diverse number and type, without limitation, of structural lines, transfer means and valves, and different but functional arrays thereof, can be utilized to bring about and affect the desired directional flow and communication of identified substances or respective fluid amounts discussed in the present disclosure and illustrated by flow arrows (→ and ←), lines and valves in the schematic drawing illustrations.

As illustrated in FIG. 1, the method and system for processing and treating a wastestream fuel or like fluid so that discharge amounts of boron can be safely lowered and selectively recovered or recycled, is shown schematically where the wastestream is provided to a source location 11 from a PWR, VVER or other boron moderated reactor (BMR). The wastestream is transferred from the source 11 through the high basic pH adjustment station 12. It will be understood that fluids within the system and method 10 can be transferred, communicated or otherwise moved or positionally changed by the use of a number of means or such means generating motive force (i.e., the Newtonian concept of a motive quantity of a force toward fluid movement, including, but not limited to pump and other such means).

The wastestream is moved from the station 12 to the first (1st) pass RO (Reverse Osmosis) unit 14. In passing through the RO unit 14 the wastestream is divided into the first pass permeate fluid 16 passing through the media of the unit 14 and the first pass reject fluid 18 that which does not pass through the media of unit 14. The first pass reject 18 contains large or substantial amounts of Boron.

The first pass permeate 16 is transferred (19) through the second high basic pH adjustment station 20, if necessary to retain high pH; and from the station 20 to the second pass RO unit 22. The permeate 16 is divided by reverse osmosis filtration into the second pass permeate 24 and the second pass reject 26. The second pass reject 26 contains residual remaining amounts of Boron. Therefore, the second pass RO 22 takes the first pass permeate 16 and further rejects most of the remaining borate. If the permeate pH drops significantly an inter-pass pH adjustment may be required to optimize the rejection.

The second pass permeate 24 is moved to the polishing demin (IX) unit 28. Within the scope of the invention 10, additional units like that of unit 28; such as for example polishing demin (IX) unit 30 shown by example in FIGS. 1, 1A, 1B, 1C, 1D, 4 and 5; can be provided to facilitate this step of the invention, thus having one or more of such units. The unit 28, and further units like this utilized as indicated, are each provided with strong base anion, boron ion selective or specific resin. The selective resin is suitable for removal of boron and regeneration using hydroxide without heavy loading with other anion species. The polishing demin units 28 and 30 (and any further such units so employed or deployed) are designed to remove the last 1-10 ppm of Boron, although higher feed concentrations can be handled by the present system and method 10. As shown in FIG. 1, by example, and described above, two demins in series permits higher loading of the lead demin, unit 28, where the lag demin, in this case demin unit 30 picks up any residual as the loading reaches the maximum on the lead vessel. In one preferred embodiment of the invention 10 the second pass permeate 24, after treatment in demin unit 28, or demin units 28 and 30, or others, if more than two such units are utilized in this step, is transferred for discharge or recycle, as set forth schematically by example in FIG. 1.

FIG. 1 also illustrates schematically that at about the same time (contemporaneously) or after the step of transferring the wastestream from the source 11 through the high basic pH adjustment station to the first pass RO 14, the first pass reject 18 is directed to an evaporation and concentration subprocess. This subprocess includes transferring or channeling 35 the first pass reject 18 to the feed holdup tank (or DDHUT) 36; channeling or otherwise communicating by line 36A (shown by example) the reject 18 to or with the high basic pH adjustment station 37 and Spent Regen transfer line (36B); and channeling or otherwise transferring the pH treated reject 18 to the drum dryer means 38 which serves for drying and evaporation of the reject to a stage of solidification. The pH Monitoring Station (36C) controls the addition of hydroxide through the pH Inj (37) or the Spent Regen area (34) through the Spent Regen transfer line (36B) to maintain the proper pH in DDHUT (36).

Also, at about the same time or after passing the first pass permeate 16 through the second pass RO 22 to generate through filtration the second pass permeate 24 and the second pass reject 26; the method 10 provides for recycling the second pass reject 26 to the first pass RO 14.

For reasons discussed throughout this disclosure, each of the high basic pH adjustment stations utilized in the present invention treat the water or fluid passing through so that the pH is adjusted to greater than about 10, and preferably greater than about 11 for the membranes (where pH of current membranes limit operating to a pH of about 11) for the purpose of maximizing the membrane rejection and solubility of the boron in the reject within the method and system 10 of the Boron in the water or fluid passing through each respective pH adjustment station, or positional area to which communication extends from each pH adjustment station, such as the stations 12 and 20, for more efficient treatment of wastestream fluids by equipment and process elements of the present invention in corresponding treatment arrangement and relation to the pH stations. In the pH Adj station (37) the pH is preferably maintained at a pH of greater than about 12.5 for the purpose of maximizing the solubility of the boron in solution during the evaporation process in drum dryer (38).

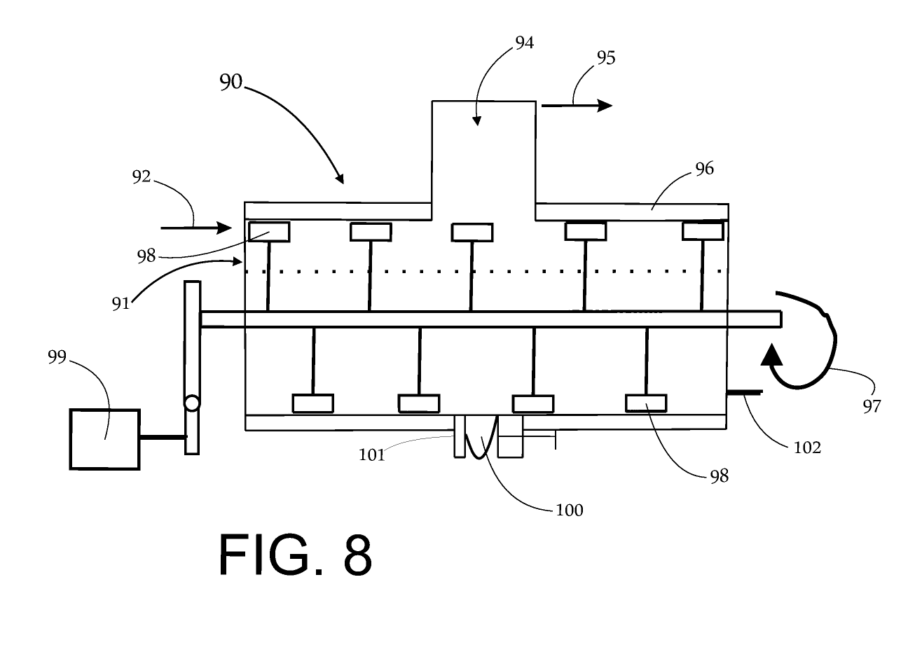

Attention is directed to FIG. 8. As a further embodiment of the present invention with regard to processing, equipment and means for evaporation and concentration, and as a preferred alternate to the subprocess or subassembly described herein as to the drum dryer holdup tank (or DDHUT) 36 and the drum dryer means (DD) 38; a paddle or fanning dryer 90 for use in vacuum or ambient conditions is substituted, where lines described as leading to the DDHUT 36 then lead to the paddle dryer 90.

The paddle dryer 90 is provided with the container member 91 of the dryer where entry is provided for feed (→) 92 from lines 35, 39B, 36A and/or the line or lines associated with these lines as shown in FIGS. 1, 1A, 2, 3, 4, and/or FIG. 7. As illustrated in FIG. 8, the paddle dryer 90 is also provided with a separation column 94, where steam 95 can be discharged, a steam or oil jacket heating area or compartment 96, pivotable paddle or fanning members 98, turned, pivoted or provided other movement 97 from the drive motor 99 or other means for providing motion or movement. The paddle dryer 90 is able to create and eject from the container member 91 of the dryer 90 a molten effluent discharge 100 by the utilization of the ball valve 101 or like means and is also provided with the temperature probe 102.

In the paddle dryer 90, the boron concentration is taken as high as possible at the high pH and the liquid sodium borate at greatly elevated temperatures (>120° C.) provide for a liquid at the elevated temperature to become a solid or solid-like fluid, shown by exemplar illustration as the molten effluent discharge 100 when discharged and cooled. An advantage to this process is that the size and shape of the disposal container can be varied to better suit disposal and reuse. The Paddles 98 utilized in this embodiment facilitate heat transfer and movement of the molten salt toward the effluent discharge 100, if the work environment or circumstances are such that this is required. The water evaporated enters the separation column 94 where the droplets of molten salt separate from the steam and fall back to the boiling mass. The separation column 94 must also be heated to prevent solidification of the molten salt. This heating is provided in this embodiment as the steam or oil jacket heating 96. Complete removal of the molten salt is not required as long as additional water is added back to the dryer through the feed 92 or other locations on the container 91 before stopping the paddles or fanning members (98).

Further, with regard to pH adjustments: The pH adjustment prior to membranes (14 m and/or 22 m) in RO units 14 and/or 22 is limited by the pH operating range of the membranes. Current conventionally available membranes have an operating range limit of approximately pH 11. Although the rejection rate may have limited improvement with a change in pH of 10.5 to 11 the solubility of the boron continues to increase as the pH increases. Therefore, an increase in feed pH could permit higher boron concentrations in the reject before precipitation would occur due to solubility issues.

Also, the removal of boron using ion exchange media has pH limitations. Depending upon the type of media employed, this pH range can change. Media that is selective for boron typically has a higher pH range for removal of boron. This both permits removal of boron from water at higher pH levels and requires higher hydroxide concentrations for regeneration. Fortunately the pH of the permeate is lower than the feed and the reject. This permeate can be as much as a pH unit (or magnitude thereof) lower than the reject. This improves the selectivity available on the IX media. The use of selective media 29 is important in this application because the higher pH which is advantageous in the RO operation restricts the media that can be used in the permeate polishing through ion exchange. However, in the long run this enhances the overall waste minimization and reduces cost on evaporation for recovery of the boron.

The use of the spent regeneration solution 33 as a source of free hydroxide for further pH adjustment of the drum dryer feed is dependent upon the regeneration process. If the pH of the spent regeneration solution (33) is higher than the reject solution (18) from the RO 14 then the regen solution (33A) can be used to aid in raising the pH. When this is the case the spent regen solution 33, subsequent to its use in regeneration, is collected in the spent regen solution tank (34) for later use in adjusting the pH through spent regen transfer line 36B. If the pH is about the same or lower, then the spent regen solution 33 can be directed through line 39B directly to the DDHUT for further pH adjustment upward using pH monitoring station 36C to control addition of hydroxide by 37 followed by evaporation in DD (38).

The pH of the spent regen solution (33) is determined by the pH required to regenerate the ion exchange media and the amount of free hydroxide remaining after regeneration. The pH in this process can be higher than that utilized in normal regeneration processes because excess hydroxide is utilized later in the process rather than to be wasted in a disposal process. Thus, higher pH ranges can improve the elution process by changing the equilibrium of the media toward hydroxide retention and boron release and making the regenerated boron soluble; therefore minimizing the volume required for regeneration. It also improves the amount of boron removed from the media thus providing for higher capacity after regeneration. For example (without limitation), if the pH of the second pass permeate 24 in FIG. 1 coming out of the second pass RO 22 were pH 11, and the regeneration solution 33 from the regen solution tank 32 provided to the IX units 28 and 30 was a pH of about 14, the emerging fluid could have a pH of about 13.5, and would be communicated on line 25 to the spent regeneration solution area 34 for later use as described.

Water is initially added 32b to the regeneration solution tank 32 to dilute the NaOH being supplied to this tank.

In the DDHUT the pH adjustment controls the solubility of boron in the drum dryer. As the pH increases, the solubility of boron increases thus permitting higher concentrations of boron to remain in solution during the evaporation cycle, and be converted to solid phase. The use of higher pH allows the boron to remain in solution during the entire evaporation cycle thus increasing the heat transfer in the drum until the maximum amount of boron desired to be solidified is reached.

The filling of the drum with solids occurs with repeated topping off of the drum from the DDHUT 36 while evaporation continues, thus maintaining maximum heat transfer in the drum. Both free water (not chemically bound) and chemically bound water to borate molecules are removed during the process as the concentration of boron increases in the drum dryer. The pH facilitates this evaporation as the solution is continually turned over in the drum due to convective currents.

Prior use of lower pH values caused the boron to precipitate on the bottom and sides of the drum, significantly decreasing the heat transfer rate to the remaining solution. This both extended the time of evaporation and the increased use of electricity to heat the drum through poor heat transfer. Using a pH of 13 permits the boron in solution to remain soluble at the elevated temperature until the evaporation process is completed signaled by minimal evaporation of water. Thus, when heat is removed the drum very quickly solidifies with only a few degrees of temperature change with no free water being present. Any remaining water is bound chemically in the solid crystalline structure generated.

The high pH changes the chemical structure of the product to a more dense crystalline structure that increases the weight of solids in the drum from about 150-200 kg/drum to about 300-400 kg/drum. The structure generated is also more glass-like and has no powdery or dispersible fines, thereby constituting significant improvement over the prior art methods and means.

Regarding RO rejection; when maintaining the feed pH at 10.5 or higher, the rejection of boron is as high as 99% as compared to 65-70% at a pH of 7. The reject concentration can be taken up to the osmotic pressure limit of the membranes. This means that about 1000 ppm boron can be reduced to less than about 1 ppm B using double pass RO.

In the present system, once the ion exchange media 29 contained in a respective demin unit is loaded with borate the unit is essentially removed from service for regeneration; i.e., the system or that section of the system or piping serving the unit, etc., is shut down. This permits the resins contained in the media in each respective IX unit taken off line to be regenerated in situ after which the entire IX unit is selectively placed back online in the system.

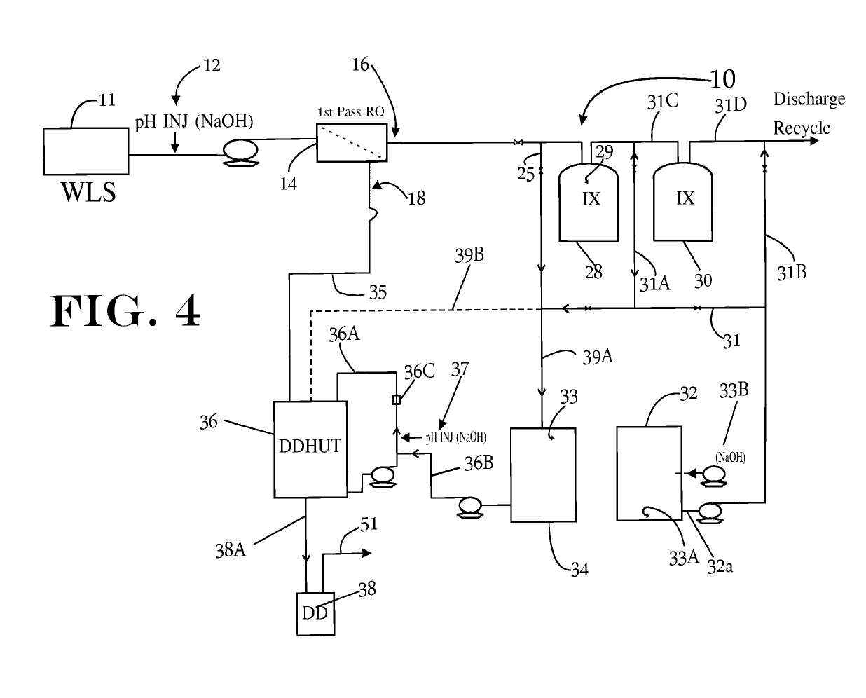

In this two (2) unit configuration in the invention, shown by example in the preferred embodiments illustrated in FIGS. 1, 4 and other drawings this leaves only a lead vessel for boron removal, the unit 28; but this has been found to work well during the early phase of loading of the vessel as no breakthrough of boron is normally detected. As illustrated by example in FIGS. 1, 1C, 1D and other drawings when these ion exchange media, and the resins contained therein, are regenerated the spent regen solution or spent regeneration solution 33, having served in bringing about such regeneration, consisting of boron and hydroxide, is passed from each respective IX unit, for example IX units 28 and 30, to the spent regen solution area 34. As indicated, it will be understood that other lines or transfer means, and different arrays thereof, can be used in this instance or line 32a, so adapted, for transfer of spent regeneration solution 33 from the Regen Tank 32 to the spent regeneration area 34. The spent regen solution 33 is suitable for treatment by drum dryer means 38 (described herein) for drying to dry solids present in the spent regen 33. The spent regen 33 also contains excess hydroxide that can be utilized for pH adjustment in the DDHUT 36. This minimizes the use of new hydroxide solution in the method and system 10. The preferable hydroxides utilized in the present invention are sodium or potassium hydroxide. However, such hydroxides can consist of any of the soluble, Mendeleev Group IA, metal hydroxides. Group IIA metal hydroxides are generally not suitable prior to the RO due to precipitation of the borates.

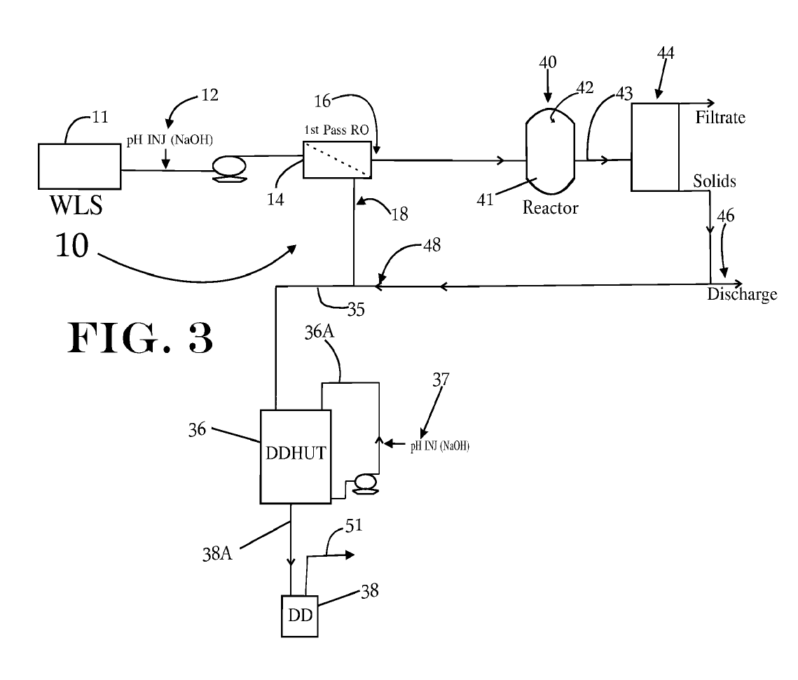

As an alternative to the demins Group IIA, hydroxides and other soluble salts of Group IIA metals can be added to precipitate remaining boron from the second pass permeate 24 as shown in FIG. 2. This chemical addition 40 of a soluble Group IIA metal salt or hydroxide to a reactor vessel 41, or similar container for this purpose, causes the precipitation of the borate 42. Barium is the preferred metal as the boride (BaB₆) is completely insoluble. The precipitate 42 is then collected and removed by solid liquid separation 44. As shown in FIG. 2, the solids can either be collected separately 46 or be added, transferred or communicated 48 to the DDHUT, and then to the drum dryer 38 for final disposal. Due to higher cost of Group IIA salts the use of the precipitation on the feed stream would be more costly than using RO to do the gross removal. RO also removes many other salts that would not be removed using only the Group IIA precipitation. In preferred embodiments of the invention the first pass reject fluid or solution 18 from the first pass RO is sent to the feed or drum dryer holdup Tank (DDHUT) 36 for feed and transfer of the feed 38A to the drum dryer means 38. The second pass (RO) reject 26 is recycled to the feed of the first pass (RO) unit 14, shown by example in FIGS. 1 and 2, as the boron concentration of the reject 26 is typically similar to that of the feed waste stream. This minimizes the volume of reject to be treated in the drum dryer means 38.

The drum dryer means 38 or other evaporative systems are used to concentrate the boron to a dry solid product that is suitable for shipment and disposal. In preferred embodiments, the drum dryer 38 is an electrically heated system with clamshell heaters and/or underside heaters to maximize the heat transfer. The drum dryer 38 is operated under vacuum to maximize the heat transfer by decreasing the boiling temperature about 30-60 degrees C. Therefore, at a given heater temperature the delta temperature across the drum is increased by from about 30 to about 60 degrees C. The lower temperature minimizes the volatilization of components that have a vapor pressure. The drum dryer 38 can also be heated through the use of steam or heated air or provided in different structural embodiments which achieve the descriptive purpose, functions and teachings of the present invention herein.

As indicated, the concentrated feed water is pH adjusted to greater than about 10 (>10) and preferably greater than about 12.5 (>12.5) to maximize the solubility of the boron in the water. This adjustment is made using either spent regen solution 33 or new hydroxide and is controlled by the pH monitor station (36C). This high pH permits the maximum amount of boron to be loaded into the drum dryer means 38 while still maintaining all fluid in the drum dryer 38. Keeping the boron in a liquid state provides both increased heat transfer and a highly dense product. High pH also prevents the volatilization of the boron in the form of boric acid.

The product, in this case, has the added benefit of not being hydroscopic where it would absorb water from the atmosphere and cause the solid to become wet on the surface. In such a state it could potentially overflow the drum dryer 38 if absorption continued. This solidified salt (or, as the case might be, possibly a form of glass) formed does not exhibit rehydration.

In the present invention the vacuum within the drum dryer 38 is also used as the motive force for transfer of the feed 38A into the drum dryer 38 from contents of the DDHUT (36) and removal of evaporate (51). By simply opening the inlet valve the concentrate is drawn into the drum without any pump or other motive force. A level measuring device is used to determine when additional feed 38A is required and when filling is complete within the drum dryer means 38.

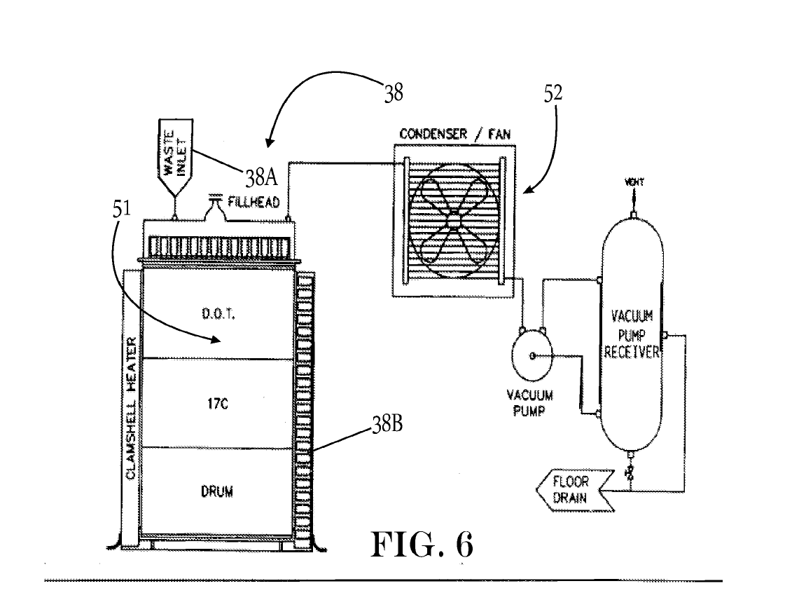

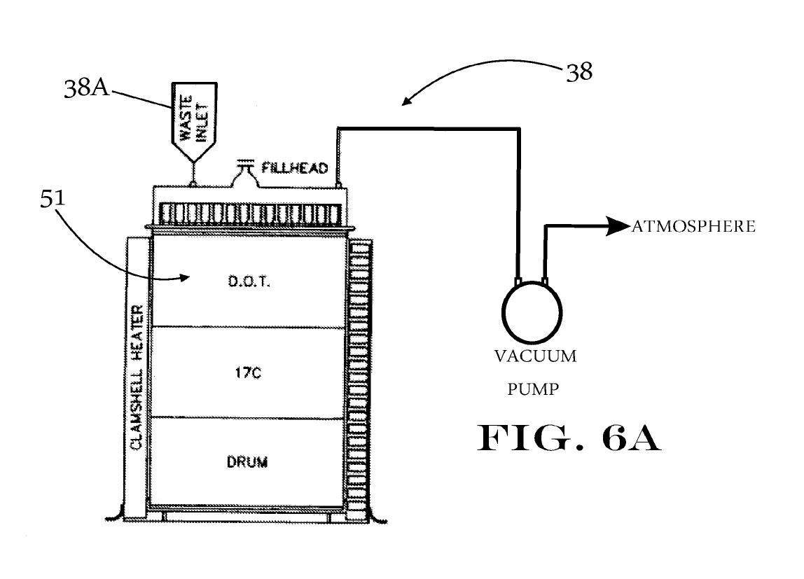

Examples, without limitation, of drum dryer means (38) employed in the present invention are set forth in the illustrations of FIGS. 6 and 6A. Other structures accomplishing the same functional method purpose may be utilized. The evaporated water or evaporate 51 generated in the drum dryer 38 as a part of the subprocess in the drum dryer (38), which is essentially free of solids, can either be discharged or recycled to the plant. The evaporate 51 is condensed using either an air or a water cooled condenser 52. The temperature of the evaporate line (not specifically shown) is measured from each drum dryer 38. When the volume of steam passing through the evaporate line decreases to a small amount the temperature of the evaporate line decreases signaling the completion of evaporation cycle. The heat is then removed from the drum and the molten mass solidifies very quickly. Once solidified, the drum (38B) of the drum dryer 38 can be changed out or replaced, and the process restarted since the temperature of the drum is at a manageable temperature level due to evaporation under vacuum as a part of the subprocess in the drum dryer 38.

A further preferred embodiment of the present invention is illustrated in FIG. 3, similar to the embodiment of FIG. 2; except that Group IIA metals are added to precipitate remaining boron from the first pass permeate 16. Similarly, in this case the chemical addition 40 of the soluble Group IIA metal salt or hydroxide to the reactor vessel 41, or similar container for this purpose, causes the precipitation of the borate 42.

FIG. 4 illustrates a preferred embodiment of the invention where only the first (1st) pass RO (Reverse Osmosis) unit 14 is utilized in relation to the method, equipment and functions described in relation to the embodiment illustrated in FIG. 1.

As discussed herein regarding the method and system 10, the invention is based around the reverse osmosis system where the feed water is pH adjusted to a pH typically higher than about 10.5, although any increase in pH, within the teaching of the invention, improves the rejection rate of membranes within the RO units 14 and 22. As the borated solution passes through the membranes of each RO unit utilized (which could be one, two, or more than two such RO units) the pH is lowered in the permeate and increased in the reject of each respective pass. Currently some membranes are restricted to a pH of about 11 for normal operating conditions but are permitted to reach a pH of about 12 during cleaning evolutions or operations. As more pH tolerant membranes are developed this pH limit may be raised to the limits of the membranes if suitable.

The pH adjustment on the first pass permeate 16 before it enters the second pass RO unit 22 will increase the rejection rate for boron, as it is better ion ionized at higher pH values. Therefore, installation or initiation of a pH adjustment, or, as provided within a preferred embodiment of the invention, communication through the second high basic pH adjustment station 20 of the first pass permeate fluid leaving the first pass RO 14 and being transferred to the second pass RO unit 22; will improve the overall system rejection of boron. Since the second pass reject 26 contains substantially less boron than the first pass reject 18, it is possible to return, by return or other communicative line 27, the second pass reject 26 to the feed of the first pass RO 14 without any substantial negative effect; and when inter-pass pH adjustment is used the residual hydroxide will help lower the feed pH without as much additional hydroxide addition.

The second pass permeate 24 is sent onto the polishing demin unit (and ion exchange media) for final polishing. Depending upon the final disposition of the boron free water, this determines the optimum ion exchange media to be utilized.

For discharge to the environment, the use of boron selective media in the present invention is advantageous since the passage of any other salts is advantageous for minimizing boron waste volumes and minimizing contamination of the boron for recycle. Therefore, removal of only boron can be optimized using the selective media.

For recycle the water must be free from all anions and cations in which case the use of more standard anion or mixed bed is preferable. Both media can utilize the same hydroxide regeneration.

As discussed herein, periodically the ion exchange media must be regenerated to restore its ability to remove boron effectively. The regeneration is typically done using hydroxide which displaces the boron and replaces the boron with hydroxide ion. The boron is collected in the spent regen tank 34 for later use as pH adjustment for the first pass RO reject. The use of the spent regen solution 33 functions to transfer the boron to the DDHUT 36 and to further elevate the pH of the solution making the boron more soluble.

Increased solubility improves the heat transfer on the drum dryer means 38 by keeping the boron in solution for the longest period until the elevated temperature solubility limit is reached. By maintaining the boron in soluble form, with pH being held above about 12.5 and near about 13, the boron solubility is such that the solution will stay in liquid form even though very viscous until the evaporation of water is minimal at which time the feed of water is stopped and the solution is permitted to solidify.

Even high pH may be advantageous if lower water content in the crystalline structure is desired.

The formation, as taught by the present invention, of the highly dense and glass-like solid material provides the minimum volume for the boron collected. If boron is collected in the acid form the product is powdery, much less dense and dispersible. In such a case, negative conditions would be present when the product contains potential radioactive contamination or could possibly be dispersed in a future event.

The evaporate 51 being generated within the subprocess of the drum dryer 38 is essentially boron free and can be recycled, reprocessed or discharged to the environment. This evaporate 51 is condensed when the vacuum operated drum dryer means 38 is utilized; or could be released directly to the environment if an open top drum is used for evaporation or a non-liquid seal vacuum pump is utilized.

An additional preferred embodiment of the present invention, shown by example in FIG. 5, is the alternate subprocess of disposal of the boron as a precipitated barium borate (BaB₆) which has a very low solubility. In this regard, the injection 62 or addition by other means (shown by example as injection to line 63) of either barium hydroxide (Ba(OH)₂) or a soluble barium salt to the reaction vessel 64, results in the boron precipitating. This precipitate 65 is sent to the solid liquid separation means 68 by reactor effluent line 66 for filtration. From the solid liquid separation 68 the precipitate 65 is utilized to remove solids in the form of BaB₆ 70 or for discharge or further treatment 72 when recycle is not possible; or for filtration or removal using other methods of solid/liquid separation.

In a basic preferred embodiment of the present invention illustrated, by example, in FIG. 5A; the present system and method 10 is set forth without the method's subsystem operation of the DDHUT (36) and DD (38). In place of the DDHUT/DD subsystem operation the present method employs the use of the reject collection tank 80. The tank 80 is utilized to house, store and/or evaluate the first pass reject (18), the spent regeneration solution (33) or other system fluids.

Yet an additional preferred embodiment of the present invention, shown by example in FIG. 7, is the alternate subprocess of using the electro-deionization (EDI) unit 73 as the final polishing step for removal of boron and other ions from the RO first pass permeate fluid (16). The EDI concentrate line 74 containing the ions removed from the RO permeate fluid (16) is utilized for return of this fluid 16 to the feed stream (11) for reprocessing.

It will thus be seen that the objects set forth above, including those made apparent from the proceeding description, are efficiently attained, and, since certain changes may be made in carrying out the above method and in construction of suitable apparatus in which to practice the method and in which to produce the desired product or results as set forth herein, it is to be understood that the invention may be embodied in other specific forms without departing from the spirit or essential characteristics thereof. For example, while we have simultaneously set forth an exemplary design where discharge amounts of boron can be lowered and selectively recovered as a solid for disposal or recycle, other embodiments are also feasible to attain the result of the principles of the method disclosed herein. Therefore, it will be understood that the foregoing description of representative embodiments of the invention have been presented only for purposes of illustration and for providing an understanding of the invention, and it is not intended to be exhaustive or restrictive, or to limit the invention to the precise forms disclosed. On the contrary, the intention is to cover all modifications, equivalents, and alternatives falling within the spirit and scope of the invention as expressed in the appended claims to be filed in the progression of this case. As such, the claims, when filed, will be intended to cover the methods and structures described therein, and not only the equivalents or structural equivalents thereof, but also equivalent structures or methods.

Therefore, the scope of the invention, as will be indicated in the claims to be later presented in the filing progression of this case will be intended to include variations from the embodiments provided which are nevertheless described by the broad meaning and range properly afforded to the language of the later claims presented, or to the equivalents thereof.

1. A system (10) for processing and treating a wastestream, NPP primary water or like fluid from a dissolved boron moderated reactor or BMR source such that discharge amounts of boron can be safely lowered and selectively recovered as a solid for disposal and recycled or reused in other fluid forms, said system comprising the following steps:
(a) communicating the wastestream from the boron moderated reactor source through a high basic pH adjustment station, and from said station to a first pass RO where said wastestream is divided by filtration into a first pass permeate and a first pass reject, said first pass reject containing a larger amount of boron;
(b) directing the first pass permeate to a second pass RO, where the permeate is divided by filtration into a second pass permeate (24) and a second pass reject (26), each leaving the second pass RO, the second pass reject containing smaller residual remaining amounts of boron; and
(c) passing at least a portion of the second pass permeate (24) to at least a first polishing demin unit or IX unit selected from a group of such units consisting of demin or IX unit (28), demin or IX unit (30) and other such units when chosen for deployment, each having ion exchange media with boron selective resin (29), and from said at least first polishing demin unit through a mode of operation chosen from a group consisting of discharge and recycle.

2. The system of claim 1; wherein, prior to (b); directing the first pass permeate to a second high basic pH adjustment station if needed to retain high pH.

3. This system (10) of claim 2, wherein, the system further comprises:
contemporaneous or after step (a), transmitting the first pass reject for evaporation and concentration; and
contemporaneous or after step (b), recycling the second pass reject to the first pass RO.

4. This system (10) of claim 3, wherein, each of the high basic pH adjustment stations adjusts to a pH equal to or greater than about 10.

5. The system (10) of claim 4, wherein, said evaporation and concentration includes a subprocess, comprising the steps of:
transmitting said first pass reject to a feed holdup tank or DDHUT (36), thereby becoming the contents thereof,
recyclably making said contents of said feed holdup tank available to a further high basic pH adjustment station on a recycle line serving the feed holdup tank, and
transferring the contents to a drying and evaporative unit or DD (38) for substantial solidification of said contents.

6. The system of claim 5, further comprising:
transferring or communicating a regeneration solution (33A) as a high basic pH fluid, to the boron selective resin (29) of said at least first polishing demin unit at selected stages of boron loading for regeneration of the selective media (29) contents in situ.

7. The system of claim 6, further comprising means for providing the regeneration solution (33A) to said at least first polishing demin unit while also serving generally, contemporaneously in providing fluid as it can be rendered at higher basic pH to the DDHUT such that boron therein, and as passed to the DD for drying and evaporation, is more soluble so as to produce a higher amount of solid boron content.

8. The system of claim 7, wherein said means for providing the regeneration solution (33A) comprises a regen solution tank (32), spent regeneration solution area (34) and coordinated communicative lines to supply target areas including the said at least first demin (IX) unit and DDHUT (36) with hydroxide containing fluid with generally higher pH than its target areas.

9. A system (10) for processing and treating a wastestream, NPP primary water or like fluid from a boron moderated reactor (BMR) such that discharge amounts of boron can be safely lowered and selectively recovered as a solid for disposal and recycled or reused in other solid or fluid forms, said system comprising the following steps:
(a) communicating the wastestream from a boron moderated reactor source through a high basic pH adjustment station, and from said station to a first pass RO (14) where the wastestream is divided by virtue of filtration into a first pass permeate (16) and a first pass reject (18), where the first pass reject contains substantial amounts of boron;
(b) directing the first pass permeate (16) to a second high basic pH adjustment station (20) when needed to retain high pH, and further directing the permeate (16) to a second pass RO (22), where the permeate is divided by virtue of filtration into a second pass permeate (24) and a second pass reject (26), each leaving the second pass RO (22), and where the second pass reject (26) contains residual remaining amounts of boron;
(c) passing at least a portion of the second pass permeate (24), to at least a first polishing demin unit or IX unit chosen from a group of such units consisting of polishing demin or IX unit (28), polishing demin or IX unit (30) and other such units selectively desired for deployment, each having ion exchange media with boron selective resin (29), and from the at least first polishing demin unit to at least one location of a group consisting of discharge and recycle; and wherein transferring a hydroxide enriched regeneration solution (33A) from a regeneration solution tank (32) to the at least first polishing demin unit for regenerating the boron selective resin (29) therein at selective stages of boron loading and generating a spent regeneration solution (33) as a source of remaining free hydroxide for use in further pH adjustment and placing or delivering the spent regeneration solution (33) to a spent regeneration area (34) for availability to other areas of the system (10); and
selectively and contemporaneously communicating or transferring the spent regeneration solution (33) to the DDHUT (36).

10. The system of claim 9, wherein:
contemporaneous or after step (a), transmitting the first pass reject (18) for evaporation and concentration; and
contemporaneous or after step (b), recycling the second pass reject (26) to the first pass RO (14).

11. The system of claim 9, wherein, prior to transferring the hydroxide enriched regeneration solution (33A) from the regeneration solution tank (32) to the at least first polishing demin unit, adding water to said tank (32) for dilution therewithin.

12. The system of claim 10, wherein, the evaporation and concentration includes a subprocess, comprising the steps of:
transmitting the first pass reject to the feed holdup tank, thereby becoming the contents thereof,
recyclably making the contents of the feed holdup tank available to a further high basic pH adjustment, and
transferring the contents to a drying and evaporative unit or DD (38) for substantial solidification of the contents.

13. The system of claim 12, wherein, the step of transferring the contents to the drying and evaporative unit for substantial solidification of the contents includes a further subprocess, comprising the steps of:
loading the contents into a pressure secure drum,
providing a vacuum environment inside the drum, and
heating the contents inside the drum, from the side of the drum or elsewhere, to substantially form a solid retaining the boron collected therein for disposal within the drum.

14. The system of claim 13, wherein, each of the high basic pH adjustments are based on a supply of at least one substance selected from a group of substances consisting of a) at least one hydroxide and b) a spent regeneration solution.

15. The system of claim 14, wherein, the hydroxide is NaOH or sodium hydroxide.

16. The system of claim 15, wherein, the at least first polishing demin unit comprises two ion exchange demin units connected in series with one another.

17. The system of claim 16, further comprising removal of at least one of the ion exchange demin units, when the resin of the ion exchange media therein is loaded with borate, for regeneration by hydroxide without heavy loading with other anion species, and subsequent placement back into service within the system.

18. The system of claim 17, wherein, the second pass permeate treated by the at least first polishing demin unit and passed to discharge or recycle, is in an aqueous form and consists of less than 1 ppm Boron.

19. A system for processing and treating the wastestream, NPP primary water or like fluid from a boron moderated reactor or source thereof so that discharge amounts of boron can be safely lowered and selectively recovered as a solid for disposal and recycled or reused in other fluid forms, where the system comprises the following steps:
(a) communicating the wastestream from the boron moderated reactor source through a high basic pH adjustment station, where the pH is adjusted to greater than about 10.5, and from this station to at least one RO unit where the wastestream is divided by filtration into a filtration pass permeate and a filtration pass reject, where the filtration pass reject contains at least residual amounts of boron;
(b) directing the filtration pass permeate from the at least one RO unit to a reactor vessel where it is treated by chemical addition of a Group II A salt to generate a borate precipitate; and
(c) passing the borate precipitate to a unit for solid/liquid separation (68).

20. The system of claim 19, wherein, the boron precipitate is communicated from the unit for solid/liquid separation (68) in at least one form selected from a group consisting of: a) a filtrate form and b) a solid form.

21. The system of claim 20, wherein, the Group IIA salt is selected from a group consisting of: 1) barium hydroxide and 2) other soluble barium salts.

22. The system of claim 21, wherein, the said b) a solid form is communicated to at least one location selected from a group consisting of 1) a location for discharge and 2) a location for treatment by a subprocess comprising a drum dryer holdup tank enclosure or DDHUT and transmittal to a drum dryer means or DD for drying, evaporation and forming of a substantially solid boron substance for disposal from therewithin.

23. A system for processing and treating a wastestream, NPP primary water or like fluid from a boron moderated reactor selected from a group consisting of a PWR, VVER and other boron moderated reactors and sources thereof such that discharge amounts of boron can be safely lowered and selectively recovered as a solid for disposal and recycled or reused in other fluid forms, where the system comprises the following steps:
(a) communicating the wastestream from one of said boron moderated reactor sources through a high basic pH adjustment station, and from the station to at least one RO where the wastestream is divided by virtue of filtration into a first pass permeate and a first pass reject;
(b) directing the first pass permeate to at least one polishing demin unit having ion exchange or (IX) media with boron selective resin, and from the at least one polishing demin unit to discharge or recycle;
(c) transmitting the first pass reject to a DDHUT (36) to become contents therewithin, the DDHUT being served and supplied by a pH monitoring station (36C) and a high basic pH adjustment station (37) for maintaining an environment of high pH inside the DDHUT to enhance boron solubility of the contents; and
(d) feeding the contents in increased boron soluble form to a drum dryer means or DD for drying and evaporation, and disposal of a solid boron substance generated therewithin in situ.

24. The system of claim 23, wherein, the boron selective resin of the ion exchange media is an Electro-deionization (EDI) unit.

25. The system of claim 12, wherein, the DDHUT, DD or other like subsytem or embodiment for supply, drying and evaporative action of the system is not utilized; and where in lieu of this a reject collection tank means (80) is used for at least one function chosen from a group consisting of loading, storing and evaluation of spent regeneration solution and other fluid contents of the system.

26. The system (10) of claim 4, wherein, said evaporation and concentration includes a subprocess, comprising at least the step of transmitting said first pass reject to a means for affecting drying and solid fluid concentration of a boron volume in the form of a molten effluent discharge for transfer into a selected disposal container of variable size based on a current job requirement.

27. The system (10) of claim 26, wherein, said means being a paddle or fanning dryer (90); said dryer (90) comprising:
a container member (91);
a liquid feed entry portion (92) to the container (91), the liquid feed hang as at least a part thereof a liquid sodium borate;
a separation column (94), wherein evaporate steam (95) being discharged;
a heating compartment (96), wherein said compartment is of the type selected from a group consisting of a steam area, an oil jacket heating area and another area or compartment positioned and equipped to provide heat to interior portions of the container (91);
pivotable paddle or fanning members for providing selected motion and movement of the contents of the container (91); and
a temperature probe extending to an interior portion of the container (91); and
a submeans for discharge of a molten solid-like fluid from the container (91); and wherein, a subprocess is employed within the container (91), comprising:
boron concentration in the container (91) being maximized by high pH and high temperature, the liquid feed sodium borate thus becoming a solid-like fluid consisting of a molten salt, which when discharged from the container and cooled becomes a hardened boron solid;
the subprocess further comprising selectively utilizing the pivotable paddle or fanning members for enhancement of heat transfer and movement of the molten salt toward the submeans for discharge, and
wherein aqueous volumes evaporated enter the separation column (94) where droplets of the molten salt separate from the solid-like fluid and are discharged from the column (94); and
wherein the column (94) is heated for prevention of solidification of the molten salt within said column (94).

28. A method for rendering a radioactive waste fluid from a nuclear reactor to a substantially solid boron form, the method comprising:
affecting an adjustment of the waste fluid to a high alkaline or basic pH chemical state;
conveying the waste fluid through at least one means of reverse osmosis filtering,
wherein when the waste fluid is so conveyed to an additional means of reverse osmosis filtering, adjusting said fluid to the high alkaline or basic pH chemical state;
conveying the waste fluid to a means for polishing said waste fluid with a regenerable anion;
communicating the waste fluid to a means and source of evaporation and substantial solidification for generating the substantially solid boron form; and
sequentially and selectively providing a regeneration fluid having a high basic pH fluid for use by the means for polishing said waste fluid and for use by said means and source of evaporation and substantial solidification for regeneration of the high alkaline and basic pH chemical state.
